(19) United States
(12) Patent Application Publication
(10) Pub. No.: US 2026/0287028 A1
(43) Pub. Date: Sep. 24, 2026

(54) CLUTCH FOR ELECTRIC VEHICLE

(71) Applicant: HYUNDAI WIA CORPORATION, Changwon-si, Gyeongsangnam-do (KR)

(72) Inventors: Won Hee HONG, Seongnam-si, Gyeonggi-do (KR); Ji Seung RYU, Hwaseong-si, Gyeonggi-do (KR); Yeong Taek LEE, Seoul (KR); Kyeong Mun LEE, Seoul (KR); Jun Hyup LEE, Seoul (KR); Jun Kee SEOL, Seoul (KR)

(21) Appl. No.: 19/479,855

(22) PCT Filed: May 3, 2024
(86) PCT No.: PCT/KR2024/005973

§ 371 Date: Oct. 29, 2025

(30) Foreign Application Priority Data
May 3, 2023 (KR) 10-2023-0057898

(51) Int. Cl. F16D 23/12; F16D 13/62; F16D 13/68

(52) U.S. Cl. CPC F16D 23/12; F16D 13/62; F16D 13/683; F16D 2023/123

(57) ABSTRACT

A clutch for an electric vehicle is disclosed. The clutch for an electric vehicle according to an embodiment of the present invention aims to stabilize power transmission efficiency in an electric vehicle by providing a clutch that prevents slip caused by thrust force and maintains stable supporting performance.

### TECHNICAL FIELD

The present invention relates to a clutch, and more particularly, to a clutch for an electric vehicle.

### BACKGROUND ART

Generally, a vehicle has two or more drive wheels, and power supplied from a power source such as an engine is appropriately distributed to each drive wheel to improve the driving performance of the vehicle.

A four-wheel drive (4WD) vehicle provides power from the power source to all four wheels so that all four wheels can be driven as drive wheels, thereby enabling an improvement in vehicle driving performance on off-road or rough terrain.

However, in terms of fuel efficiency, a two-wheel drive (2WD) vehicle is more advantageous, and it becomes more favorable for fuel efficiency when the 2WD and 4WD states are variably controlled according to the driving conditions of the vehicle.

Meanwhile, even in a 2WD situation, when torque vectoring is possible by actively performing torque distribution between left and right drive wheels, the driving stability and power performance of the vehicle can be improved.

As described above, in order to vary between the 2WD and 4WD states, it is necessary to appropriately distribute the torque supplied from the power source between the front and rear wheels, and in order to actively vary the torque between the left and right drive wheels, it is necessary to appropriately distribute the torque supplied from the power source between the left and right drive wheels.

For example, in a drum-integrated twin clutch system, the drum is configured as an integrated body to transmit torque generated from the power source (a drive gear of a reducer) to the left and right clutch packs.

During torque transmission, bearings must be disposed on both the left and right sides to support the axial direction of the drum, and as a result, the drum inevitably assumes a closed shape that encloses the left and right clutch packs. In such a structure, a snap ring is installed on the drum to support the thrust force of a ball ramp.

However, due to the characteristics of the snap ring, when a large load is generated, deformation occurs in the snap ring, and such deformation causes a reduction in the engagement responsiveness of the entire clutch system, thereby necessitating a countermeasure.

### DISCLOSURE

### Technical Problem

Embodiments of the present invention are intended to provide a clutch for an electric vehicle that is capable of maintaining stable operation and supporting performance when provided in the electric vehicle.

### Technical Solution

A clutch for an electric vehicle according to an embodiment of the present invention includes a drum unit 100, a pair of clutch units 200, each having a plurality of clutch plates 202 provided along the inner longitudinal direction of the drum unit 100, a pair of reaction plate units 300 coupled to the drum unit 100 to prevent rotation of the clutch plates 202, a shaft 400 coupled to the drum unit 100, a pair of spring plates 500 coupled from the outside of the shaft 400 toward the clutch plates 202, a pair of ball ramps 600 provided outside the spring plates 500, and a pair of cam plates 700 provided with anti-rotation portions 710 to maintain a coupled state with the shaft 400.

The drum unit 100 is formed to a size that covers the entirety of the clutch units 200.

The drum unit 100 is formed with an insertion groove 110 into which a radially outer end of the reaction plate unit 300 is partially inserted.

The reaction plate unit 300 is inserted into the insertion groove 110 with a width corresponding to that of the groove.

The drum unit 100 is formed with a first toothed portion 120 extending in an inner axial direction and engaged with the reaction plate unit 300, and a drum stopper 122 formed on the first toothed portion 120 to position the reaction plate unit 300 at an installation location on the drum unit 100.

The reaction plate unit 300 is formed with a second toothed portion 310 repeatedly along a circumferential direction.

The reaction plate unit 300 is provided with a fixing pin 10 coupled to the second toothed portion 310 to fix the position on the drum unit 100.

The fixing pin 10 is symmetrically coupled in upper, lower, left, and right directions with respect to a center of the reaction plate unit 300.

The shaft 400 includes a first shaft 410 engaged with a driven gear and coupled to the drum unit 100 to transmit power, and a second shaft 420 spaced apart from the first shaft 410 in an axial direction at a predetermined interval and coupled to the drum unit 100 to transmit power, the shaft 400 being provided with an anti-rotation portion 710 and a stopper 430 configured to maintain engagement.

The stopper 430 extends a predetermined length along an outer circumferential direction of the shaft 400, and a surface thereof facing the cam plate 700 forms a first flat portion 432.

The anti-rotation portion 710 is divided into N portions along an inner circumferential direction of the cam plate 700 and spaced at equal intervals.

The anti-rotation portion 710 extends a predetermined length along the inner circumferential direction of the cam plate 700, and a second flat portion 712 is formed in surface contact with the first flat portion 432.

The anti-rotation portion 710 is provided with an anti-rotation protrusion 714 to prevent disengagement when coupled with the stopper 430.

The anti-rotation protrusion 714 protrudes a predetermined height in an axial direction of the shaft 400.

The assembly of the stopper 430 and anti-rotation protrusion 714 defines a third length L3 as a spacing between the drum unit 100 positioned opposite the shaft 400 in an axial direction, a first length L1 as a spacing extending from one side of the stopper 430 along the axial direction toward the anti-rotation protrusion 714, and a second length L2 as a spacing between the shaft 400 and the cam plate 700 in the axial direction, the third length L3 and the second length L2 being longer than the first length L1.

The third length L3 corresponds to a clutch clearance, the second length L2 corresponds to an assembly allowance of the cam plate 700, and the first length L1 corresponds to the height of the anti-rotation protrusion 714.

The ball ramp 600 further includes an apply cam 610 coupled to the spring plate 500; and a base cam 620 coupled to the apply cam 610.

### Advantageous Effects

Embodiments of the present invention are advantageous in preventing slip from occurring in a clutch installed in an electric vehicle and in achieving stable operation.

These embodiments are advantageous for improving responsiveness and control accuracy by changing the structure and configuration so as to stably transmit the thrust force generated during clutch operation while simultaneously supporting components without deformation.

### DESCRIPTION OF DRAWINGS

FIG. 1 is a cross-sectional view illustrating the configuration of a clutch for an electric vehicle according to an embodiment of the present invention;

FIG. 2 is a longitudinal cross-sectional perspective view of a clutch for an electric vehicle according to an embodiment of the present invention;

FIG. 3 is a perspective view illustrating a drum unit according to an embodiment of the present invention;

FIGS. 4 and 5 are perspective views illustrating a state in which a reaction plate unit is additionally inserted into the drum unit according to an embodiment of the present invention;

FIG. 6 is a view illustrating a state in which the drum unit and the reaction plate unit are coupled by a fixing pin according to an embodiment of the present invention;

FIG. 7 is a perspective view illustrating a shaft according to an embodiment of the present invention;

FIGS. 8 and 9 are perspective views illustrating a state in which a cam plate is coupled to the shaft according to an embodiment of the present invention; and

FIG. 10 is a cross-sectional view illustrating a cam plate and a shaft to which the cam plate is coupled according to an embodiment of the present invention.

### MODE FOR INVENTION

Advantages and features of the present disclosure and methods of accomplishing the same may be understood more readily by reference to the detailed description of embodiments that will be made hereinafter with reference to the accompanying drawings. The present disclosure may, however, be embodied in many different forms and should not be construed as being limited to the exemplary embodiments set forth herein; rather, these exemplary embodiments are provided so that this disclosure will be thorough and complete and will fully convey the concept of the invention to those skilled in the art, and the present disclosure will only be defined by the appended claims. Throughout the specification, the same reference numerals refer to the same components.

When a component is described as “connected to” or “coupled to” another component, it can refer to a direct connection or coupling with the other component, or to a case where another component is interposed therebetween. Meanwhile, when a component is referred to as “directly connected to” or “directly coupled to” another component, it indicates that there is no other component interposed therebetween. The expression “and/or” is taken to include each of the mentioned items and any combination of one or more.

The terminology used in this specification is for the purpose of describing embodiments, and is not intended to limit the present disclosure. In this specification, the singular form includes the plural form unless otherwise specified in the phrase. The “comprises” and/or “comprising” used in the specification do not preclude the presence or addition of one or more other components, steps, operations, and/or devices mentioned.

Although the terms “first,” “second,” and the like are used for describing various components, these components are not confined by these terms. These terms are merely used for distinguishing one component from the other components.

A clutch for an electric vehicle according to an embodiment of the present invention will be described with reference to the drawings. For reference, the present embodiment relates to a clutch installed in an electric vehicle, and the structure has been modified to prevent clutch slip and simultaneously improve durability, taking into consideration the conditions requiring more precise responsiveness than in conventional internal combustion engine vehicles.

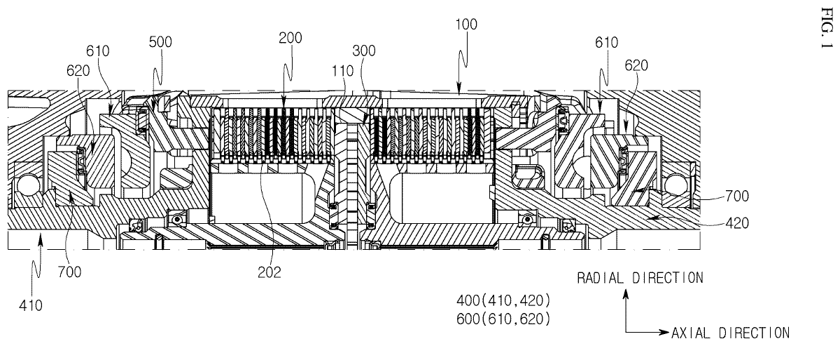

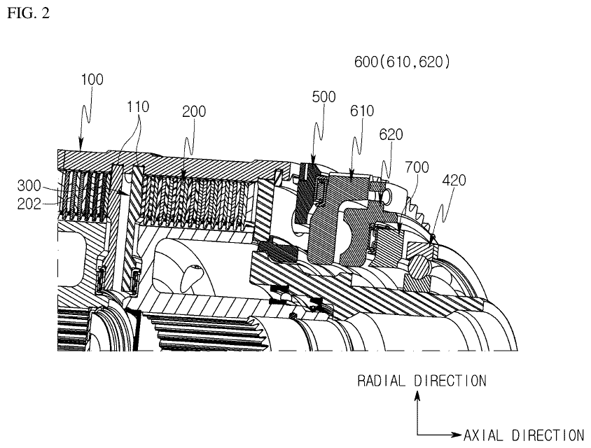

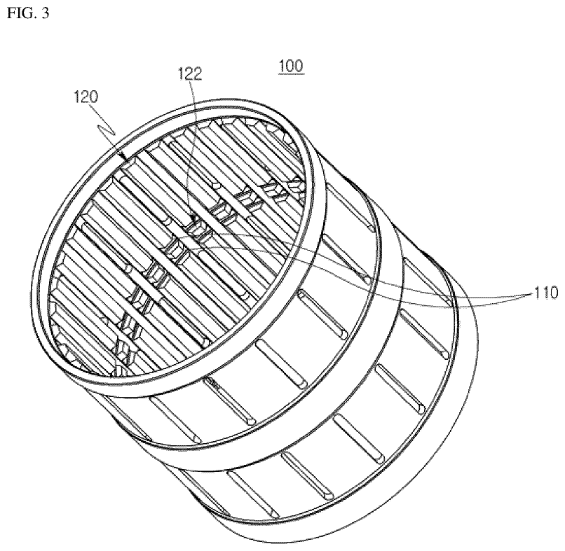

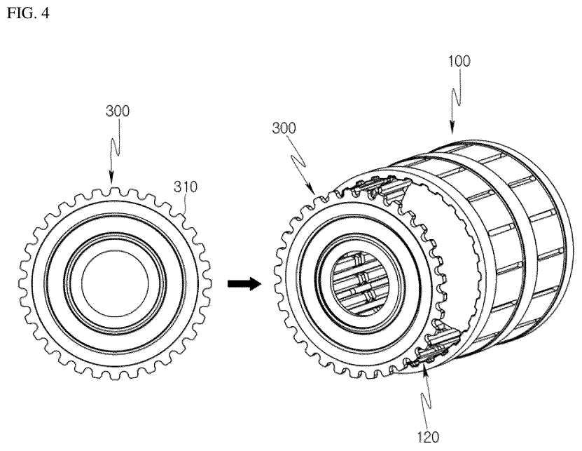

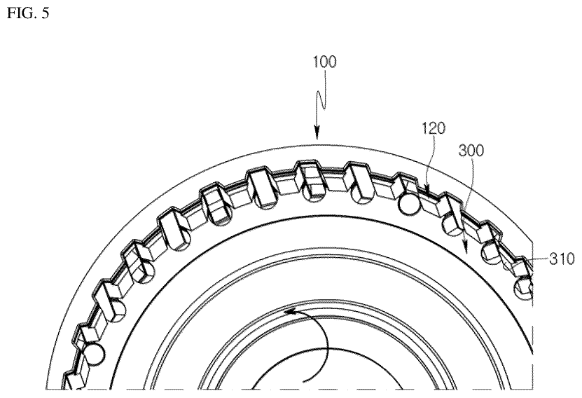

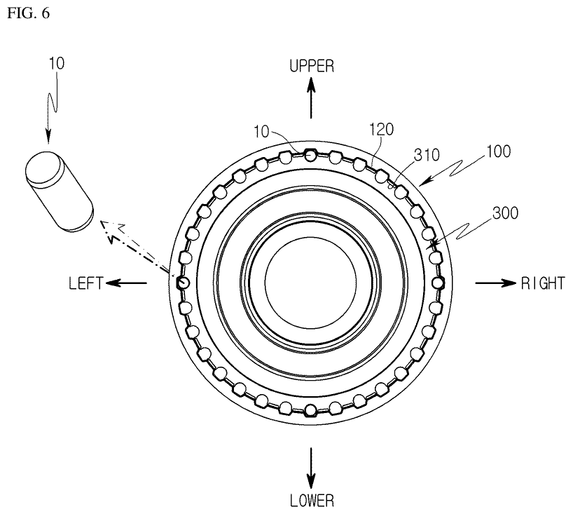

Referring to FIGS. 1 to 5, the present embodiment includes a drum unit 100, a pair of clutch units 200 each including a plurality of clutch plates 202 provided along the inner longitudinal direction of the drum unit 100, a pair of reaction plate units 300 coupled to the drum unit 100 to prevent rotation of the clutch plates 202, a shaft 400 coupled to the drum unit 100, a pair of spring plates 500 coupled from the outside of the shaft 400 toward the clutch plates 202, a pair of ball ramps 600 provided outside the spring plates 500, and a pair of cam plates 700 including an anti-rotation portion 710 configured to maintain a coupled state with the shaft 400.

The drum unit 100 is formed to have a size that covers the entire outer portion of the clutch unit 200 and extends to a size in which the clutch unit 200, to be described later, is contained therein.

The drum unit 100 is formed in this manner to prevent deformation caused by the thrust force generated during electric vehicle operation.

The drum unit 100 is provided with an insertion groove 110 such that the radially outer end of the reaction plate unit 300 is partially inserted therein, and the reaction plate unit 300 has a width corresponding to the insertion groove 110 so that insertion is achieved.

The insertion groove 110 has a thickness corresponding to the thickness of the radially outer end of the reaction plate unit 300 and is formed to a predetermined depth, thereby maintaining stable insertion of the reaction plate unit 300.

The drum unit 100 is formed with a first toothed portion 120 along the inner axial direction to engage with the reaction plate unit 300, and a drum stopper 122 is formed on the first toothed portion 120 to position the reaction plate unit 300 at the installation location of the drum unit 100.

The first toothed portion 120 extends along the inner axial direction of the drum unit 100, and the reaction plate unit 300 is formed with a second toothed portion 310 repeatedly along the circumferential direction, such that the reaction plate unit 300 can be coupled to the first toothed portion 120.

As illustrated in the drawings, the reaction plate unit 300 is coupled in the axial direction by the second toothed portion 310, which meshes with the first toothed portion 120 formed on the inner side of the drum unit 100.

The drum stopper 122 is formed along the inner circumferential direction to ensure that the reaction plate unit 300 is positioned at the correct installation location, thereby enabling stable installation of the reaction plate unit 300.

For reference, the radially lower portion of the reaction plate unit 300 is supported by a bearing, thereby allowing stable coupling with the drum unit 100 and reliable transmission of rotational force.

The reaction plate unit 300 is provided with fixing pins 10, which are coupled to the second toothed portion 310 to secure the position of the reaction plate unit 300 within the drum unit 100. Each fixing pin 10 extends to a length as illustrated in the drawings, but its shape and length may be varied.

The fixing pins 10 are arranged symmetrically about the center of the reaction plate unit 300 in the vertical and horizontal directions, thereby maintaining a stable fixed state of the reaction plate unit 300. In particular, when a thrust force is applied, rotation of the reaction plate unit 300 is prevented, and the reaction plate unit 300 remains stably supported while coupled to the drum unit 100, ensuring that the supported state is consistently maintained.

For example, the fixing pins 10 may be installed at the 12 o'clock, 3 o'clock, 6 o'clock, and 9 o'clock positions when viewed from the outside of the drum unit 100, thereby maintaining a stable coupling with the reaction plate unit 300.

Accordingly, when the clutch operates and rotational force is transmitted from the reaction plate unit 300 to the drum unit 100, disengagement is prevented.

As illustrated in the drawings, the clutch unit 200 according to the present embodiment is coupled with a plurality of plates such that rotational force can be transmitted within the drum unit 100.

The shaft 400 is engaged with a driven gear and includes a first shaft 410 coupled to transmit power to the drum unit 100, and a second shaft 420 spaced apart from the first shaft 410 in the axial direction and coupled to transmit power to the drum unit 100.

Since the first shaft 410 and the second shaft 420 are maintained in a splined engagement with the drum unit 100, when the driven gear rotates, rotational force is transmitted to the first shaft 410 and, at the same time, the rotational force of the first shaft 410 is transmitted to the second shaft 420, causing it to rotate.

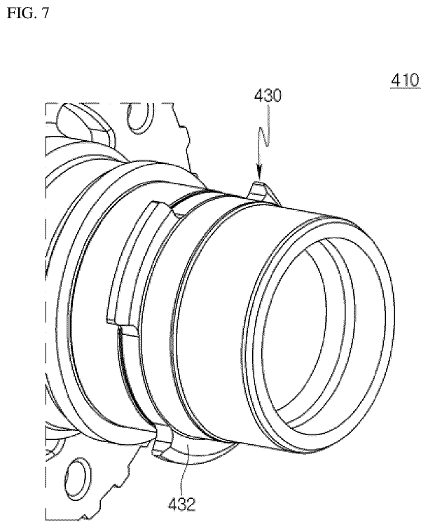

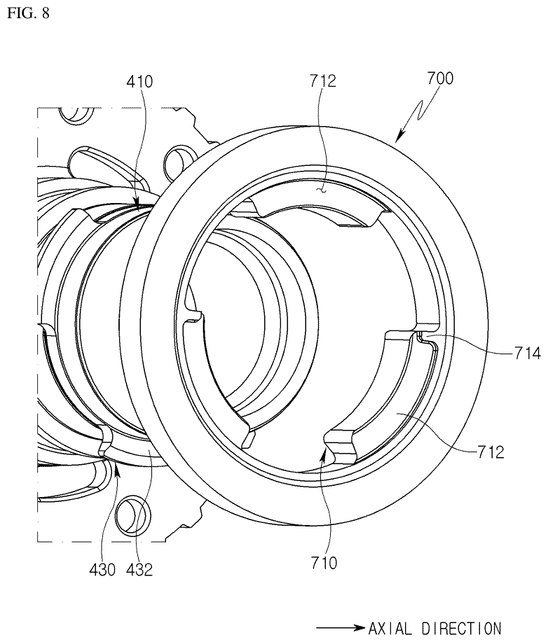

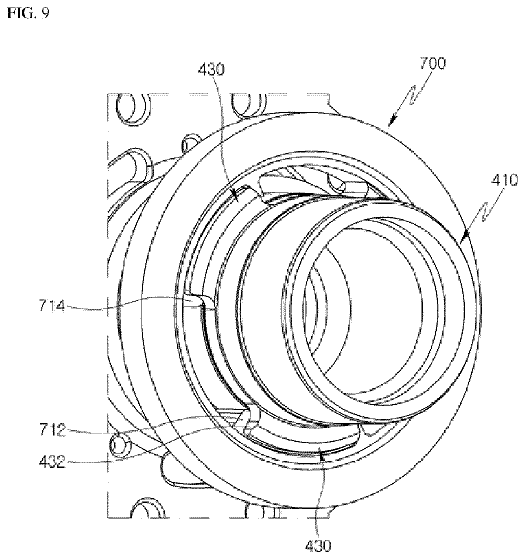

Referring to FIGS. 7 to 9, the shaft 400 according to the present embodiment is provided with an anti-rotation portion 710 and stoppers 430 configured to maintain engagement, the stoppers 430 being formed on the first and second shafts 410 and 420, respectively, to maintain a physical coupling relationship with the cam plate 700.

As illustrated in the drawings, a plurality of stoppers 430 are spaced apart at equal intervals, such that when coupled with the cam plate 700, the coupling force is maintained stably and slip is prevented, enabling use in vehicles such as electric vehicles without a decrease in responsiveness.

Each stopper 430 extends along a predetermined length in the outer circumferential direction of the shaft 400, and a first flat portion 432, which faces the cam plate 700, is formed on a corresponding surface.

The first flat portion 432 will be described in more detail in conjunction with the description of the cam plate 700.

In the present embodiment, the cam plate 700 is provided with an anti-rotation portion 710 to stably support the thrust force of the ball ramps 600, which will be described later, when the clutch operates.

The anti-rotation portion 710 is divided into N sections along the inner circumferential direction of the cam plate 700, spaced apart at equal intervals, and corresponds in number to the stoppers 430 described above.

The anti-rotation portion 710 extends along a predetermined length in the inner circumferential direction of the cam plate 700, and a second flat portion 712, which is in surface contact with the first flat portion 432, is formed. The second flat portion 712 must remain in surface contact with the first flat portion 432 of the stopper 430 over the maximum possible area in order to stably support the thrust force generated during operation of the ball ramps 600.

After being installed on the first and second shafts 410 and 420, the cam plate 700 is axially supported by bearings, and the second flat portion 712 remains in face-to-face contact with the first flat portion 432, which is advantageous for transmitting rotational force.

The anti-rotation portion 710 is provided with an anti-rotation protrusion 714 to prevent disengagement when coupled with the stopper 430. The anti-rotation protrusion 714 projects a predetermined height in the axial direction of the shaft 400.

The reason for the projection of the anti-rotation protrusion 714 is that the stopper 430 formed on the first and second shafts 410 and 420 engages with the anti-rotation protrusion 714, thereby stably maintaining the coupled state of the cam plate 700 with the first and second shafts 410 and 420.

In particular, after the cam plate 700 is installed on the first and second shafts 410 and 420, it remains in tight engagement with the stoppers 430, such that when rotational force is transmitted to the drum unit 100, slip is prevented, the coupling relationship is reliably maintained at all times, and structural rigidity is ensured.

At least two of the N anti-rotation portions 710 are provided with anti-rotation protrusions 714, which engage with one end of the stopper 430 and remain in close contact, thereby maintaining the state described above.

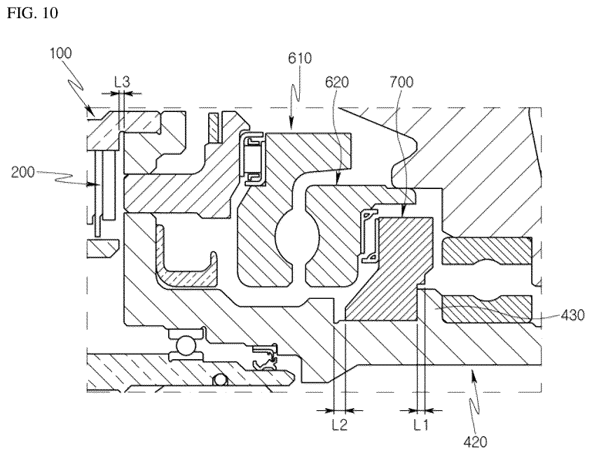

Referring to FIG. 10, in the present embodiment, the stopper 430 is assembled in a state maintaining engagement with the anti-rotation protrusion 714, wherein the axial spacing between the shaft 400 and the drum unit 100 positioned opposite the shaft 400 is defined as a third length L3, the axial spacing from the stopper 430 toward the side along which the anti-rotation protrusion 714 extends is defined as a first length L1, and the axial spacing between the shaft 400 and the cam plate 700 is defined as a second length L2, with the third length L3 and the second length L2 being longer than the first length L1.

The third length L3 corresponds to the clutch clearance, the second length L2 corresponds to the assembly allowance of the cam plate 700, and the first length L1 corresponds to the height of the anti-rotation protrusion 714.

For example, the third length L3 is 2.0 mm, and the first length L1 is 1.5 mm. In this case, the assembly between the stopper 430 and the anti-rotation protrusion 714, resulting from the coupling between the shaft 400 and the cam plate 700, can be reliably achieved.

When the cam plate 700 is assembled with the stopper 430 in this manner, assembly of the cam plate 700 is facilitated, and the engagement of the anti-rotation protrusions 714 with the stoppers 430 on the first and second shafts 410 and 420 can be consistently maintained.

Accordingly, in the present embodiment, the reaction plate unit 300 and the cam plate 700 can be stably supported without installing separate snap rings, ensuring that rotational force is transmitted with consistently stable responsiveness and that control accuracy during clutch operation is maintained, thereby improving the driving performance of the electric vehicle.

The ball ramps 600 further include an apply cam 610 coupled to the spring plate 500 and a base cam 620 coupled to the apply cam 610.

The apply cam 610 is coupled to transmit rotational force through the spring plate 500 and a bearing, and the base cam 620 is coupled to transmit rotational force to the cam plate 700.

In the clutch according to the present embodiment, the thrust force of the apply cam 610 is transmitted to the drum unit 100 via the spring plate 500, the clutch unit 200, and the reaction plate unit 300.

In addition, the thrust force of the base cam 620 is reliably transmitted to the first and second shafts 410 and 420 through the cam plate 700 without generating slip.

Although the description has been made with example embodiments of the present invention, those skilled in the art will appreciate that various modifications and changes, such as addition, alteration, and deletion of components, can be made to the present invention without departing from the spirit and scope of the invention as set forth in the appended claims, and such modifications and changes are also included within the scope of the invention.

### INDUSTRIAL APPLICABILITY

The embodiments of the present invention aim to stabilize power transmission efficiency in an electric vehicle by providing a clutch for use in an electric vehicle that prevents slip caused by thrust force and maintains stable supporting performance.

1. A clutch for an electric vehicle, comprising:
a drum unit 100;
a pair of clutch units 200, each having a plurality of clutch plates 202 provided along the inner longitudinal direction of the drum unit 100;
a pair of reaction plate units 300 coupled to the drum unit 100 to prevent rotation of the clutch plates 202;
a shaft 400 coupled to the drum unit 100;
a pair of spring plates 500 coupled from the outside of the shaft 400 toward the clutch plates 202;
a pair of ball ramps 600 provided outside the spring plates 500; and
a pair of cam plates 700 provided with anti-rotation portions 710 to maintain a coupled state with the shaft 400.

2. The clutch of claim 1, wherein the drum unit 100 is formed to a size that covers the entirety of the clutch units 200.

3. The clutch of claim 1, wherein the drum unit 100 is formed with an insertion groove 110 into which a radially outer end of the reaction plate unit 300 is partially inserted.

4. The clutch of claim 3, wherein the reaction plate unit 300 is inserted into the insertion groove 110 with a width corresponding to that of the groove.

5. The clutch of claim 1, wherein the drum unit 100 is formed with a first toothed portion 120 extending in an inner axial direction and engaged with the reaction plate unit 300, and a drum stopper 122 formed on the first toothed portion 120 to position the reaction plate unit 300 at an installation location on the drum unit 100.

6. The clutch of claim 1, wherein the reaction plate unit 300 is formed with a second toothed portion 310 repeatedly along a circumferential direction.

7. The clutch of claim 6, wherein the reaction plate unit 300 is provided with a fixing pin 10 coupled to the second toothed portion 310 to fix the position on the drum unit 100.

8. The clutch of claim 7, wherein the fixing pin 10 is symmetrically coupled in upper, lower, left, and right directions with respect to a center of the reaction plate unit 300.

9. The clutch of claim 1, wherein the shaft 400 comprises:
a first shaft 410 engaged with a driven gear and coupled to the drum unit 100 to transmit power; and
a second shaft 420 spaced apart from the first shaft 410 in an axial direction at a predetermined interval and coupled to the drum unit 100 to transmit power,
the shaft 400 being provided with an anti-rotation portion 710 and a stopper 430 configured to maintain engagement.

10. The clutch of claim 9, wherein the stopper 430 extends a predetermined length along an outer circumferential direction of the shaft 400, and a surface thereof facing the cam plate 700 forms a first flat portion 432.

11. The clutch of claim 1, wherein the anti-rotation portion 710 is divided into N portions along an inner circumferential direction of the cam plate 700 and spaced at equal intervals.

12. The clutch of claim 10, wherein the anti-rotation portion 710 extends a predetermined length along the inner circumferential direction of the cam plate 700, and a second flat portion 712 is formed in surface contact with the first flat portion 432.

13. The clutch of claim 9, wherein the anti-rotation portion 710 is formed with an anti-rotation protrusion 714 to prevent disengagement when coupled with the stopper 430.

14. The clutch of claim 13, wherein the anti-rotation protrusion 714 protrudes a predetermined height in an axial direction of the shaft 400.

15. The clutch of claim 14, wherein the assembly of the stopper 430 and anti-rotation protrusion 714 defines a third length L3 as a spacing between the drum unit 100 positioned opposite the shaft 400 in an axial direction, a first length L1 as a spacing extending from one side of the stopper 430 along the axial direction toward the anti-rotation protrusion 714, and a second length L2 as a spacing between the shaft 400 and the cam plate 700 in the axial direction, the third length L3 and the second length L2 being longer than the first length L1.

16. The clutch of claim 15, wherein the third length L3 corresponds to a clutch clearance, the second length L2 corresponds to an assembly allowance of the cam plate 700, and the first length L1 corresponds to the height of the anti-rotation protrusion 714.

17. The clutch of claim 5, wherein the ball ramp 600 further comprises:
an apply cam 610 coupled to the spring plate 500; and
a base cam 620 coupled to the apply cam 610.
